(19) United States
(12) Patent Application Publication
(10) Pub. No.: US 2008/0016113 A1
(43) Pub. Date: Jan. 17, 2008

(54) NETWORK ACCESS TOOL BAR SYSTEMS AND METHODS

(75) Inventors: David L. Theobald, Highlands Ranch, CO (US); James P. Arnot, Highlands Ranch, CO (US); John D. Cashman, Quincy, IL (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Novus Technologies, Inc., Highlands Ranch, CO (US)

(21) Appl. No.: 11/456,791

(22) Filed: Jul. 11, 2006

(51) Int. Cl. G06F 17/00

(52) U.S. Cl. 707/104.1

(57) ABSTRACT

A method of providing access to a network includes, at a network access point, receiving from a user computer a request for a network resource and forwarding the request to the network. The method further includes, at the network access point, intercepting an inbound transmission in response to the request. The transmission includes the network resource and the transmission is directed to the user computer. The method also includes inserting code into the resource and forwarding the resource to the user computer. The method also include, at the user computer, executing the code. The code is programmed to render a tool bar in a content area of a web browser window rendered on a display associated with the user computer.

Embodiments of the present invention relate generally to network access utilities. More specifically, embodiments of the invention relate to an intelligent tool bar for accessing network content.

### BACKGROUND OF THE INVENTION

The deployment of Wireless Fidelity networks (Wi-Fi) and the rapid growth of these networks are providing users with more frequent network access opportunities. Wi-Fi “Hotspots” or “Hotzones” are being established daily in municipalities, hotels and motels, restaurants, coffee shops, sports bars, transportation hubs, and other places of public accommodation. Over 90% of laptops sold today are Wi-Fi enabled, and for the first time since the advent of the personal computer, sales of laptops exceed those of desktops, clearly indicating the public's demand for mobile internet connectivity.

The Wi-Fi market is in its infancy. Currently, there are approximately 50,000 hotspots in the United States. It is estimated that this number will exceed 300,000 by the end of 2007. As the Wi-Fi market has grown, and continues to grow, opportunities to generate revenue have changed. Traditionally, Wi-Fi venues charged a user fee for the wireless connection. As the Wi-Fi landscape expands, venues are finding it necessary to offer Wi-Fi connectivity free of charge. The hospitality industry, in particular, is finding it necessary to accommodate this expectation of free Wi-Fi service as a standard hotel amenity.

The combination of rapid growth in Wi-Fi demand together with customer-expectations regarding price are creating the need for better network access solutions.

### BRIEF SUMMARY OF THE INVENTION

Embodiments of the invention provide a method of providing access to a network. The method includes, at a network access point, receiving from a user computer a request for a network resource and forwarding the request to the network. The method further includes, at the network access point, intercepting an inbound transmission in response to the request. The transmission includes the network resource and the transmission is directed to the user computer. The method also includes inserting code into the resource and forwarding the resource to the user computer. The method also include, at the user computer, executing the code. The code is programmed to render a tool bar in a content area of a web browser window rendered on a display associated with the user computer.

In some embodiments, the tool bar includes a button, a dropdown menu, a pick list, a sponsor logo, a search engine, and/or the like. Executing the code may include requesting tool bar content from a server local to the access point, receiving the request at the server, providing the content to the user computer, and placing the content in the tool bar. The content may include advertising and/or applications. The applications may include instant messaging, conferencing, media streaming, voice messaging, and/or the like. The content may include code programmed to request additional content from a server remote from the access point. Executing the code may include requesting tool bar content from a server remote from the access point, receiving the request at the server, providing the content to the user computer, and placing the content in the tool bar. The code may include Macromedia Flash code.

Other embodiments provide a network access hub. The hub includes means for intercepting an inbound transmission of a network resource requested from a user computer and means for inserting code into the inbound transmission. The code is programmed to render a tool bar in a content area of a web browser window operating on the requesting user computer. The code may include Macromedia Flash code. The tool bar may include a button, a dropdown menu, a pick list, a sponsor logo, and a search engine. The code may request tool bar content from a server remote from the access point, receive the request from the server, and place the content in the tool bar.

Still other embodiments provide a method of providing network access. The method includes establishing business relationships with one or more advertisers, storing tool bar content related to the advertiser at a server, at an access point, intercepting an inbound transmission of a network resource requested from a user computer, and inserting code into the inbound transmission. The code is programmed to render a tool bar in a content area of a web browser window operating on the requesting user computer. The method also includes executing the code at the user computer. Executing the code includes requesting the tool bar content from the server. In such embodiments, the code may be Macromedia Flash code.

Yet other embodiments provide a system for providing network access. The system includes a server configured to store content for a tool bar and a network access hub configured to intercept an inbound transmission of a network resource requested from a user computer and insert code into the inbound transmission. The code is programmed to render the tool bar in a content area of a web browser window operating on the requesting user computer. The code is further configured to request the content from the server and populate the content into the tool bar. The code may be further configured to receive content pushed to the tool bar from the server and populate the content into the tool bar. The server may be remote from the network access hub.

### BRIEF DESCRIPTION OF THE DRAWINGS

A further understanding of the nature and advantages of the present invention may be realized by reference to the figures which are described in remaining portions of the specification. In the figures, like reference numerals are used throughout several figures to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 depicts a system for providing network access according to embodiments of the invention.

FIG. 2 depicts a more detailed view of an access hub from the system of FIG. 1.

FIG. 3 depicts a method of providing network access according to embodiments of the invention, which method may be implemented in the system of FIG. 1.

FIGS. 4A and 4B depict registration screens according to embodiments of the invention.

FIG. 5A depicts a screen display of a network access tool bar rendered in a content area of a web browser according to embodiments of the invention.

FIG. 5B depicts another view of a tool bar according to embodiments of the invention.

### DETAILED DESCRIPTION OF THE INVENTION

Embodiments of the present invention provide, among other things, an intelligent tool bar for use in association with a web browser for accessing a network, such as the Internet. The tool bar may include buttons, menus, pick lists, data entry fields, and/or any of a variety of tools familiar to those who use the Internet, an intranet, and/or any of a variety of software products. The tool bar may be adaptable to a user, a user's location, a network access provider, and/or the like. The tool bar may be placed within a content area of a web browser window even though not necessarily generated by the browser. In specific embodiments, the tool bar adapts to any browser.

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It is to be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, systems may be shown in block diagrams in order not to obscure the embodiments in unnecessary detail. In other instances, well-known processes, structures and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

According to embodiments of the invention, a user may connect wired or wirelessly to a network access point, or access hub, operated by an access provider. The access provider may be the owner of the physical location of the network access point or may be providing a service on behalf of the location owner. In some embodiments, the tool bar is used in combination with free or reduced-rate network access, in exchange for which the tool bar includes revenue generating features.

In some embodiments, for example, buttons are placed on the tool bar according to business agreements that provide revenue to the access provider. The buttons may be related to the physical location, the user's demographics, the user's network usage habits, the time of day, the day of the week, and/or the like. In a specific example, the physical location is a hotel and one of the buttons placed on the tool bar provides the user with a link to hotel activities. In another embodiments, the network access is provided in association with a convention and conventioneers are able to access the network in exchange for having the tool bar rendered in their web browser window. The tool bar includes convention-specific items such as, for example, a convention map, a schedule of activities, presentation notes, announcements, local restaurants, hotels, and transportation providers, and/or the like. In some embodiments, the tool bar facilitates other features, such as, for example, instant messaging, email, collaboration/conferencing, bulletin boards, threaded discussions, alerts, streaming media, voice communication (e.g., VoIP), secured communication, location mapping, hosted applications, and/or the like. The tool bar also may link to web pages hosted by the access provider, which web pages provide both information to users and advertising real estate for additional revenue generation. In some embodiments, the tool bar is configured to receive pushed content. This may take place dynamically, while the web page remains static. In other words, the tool bar may act as a portal through which content may be pushed to the user. The content may be alerts, announcements, offers (e.g., coupons for local bars and restaurants), and/or the like. Many such examples are possible.

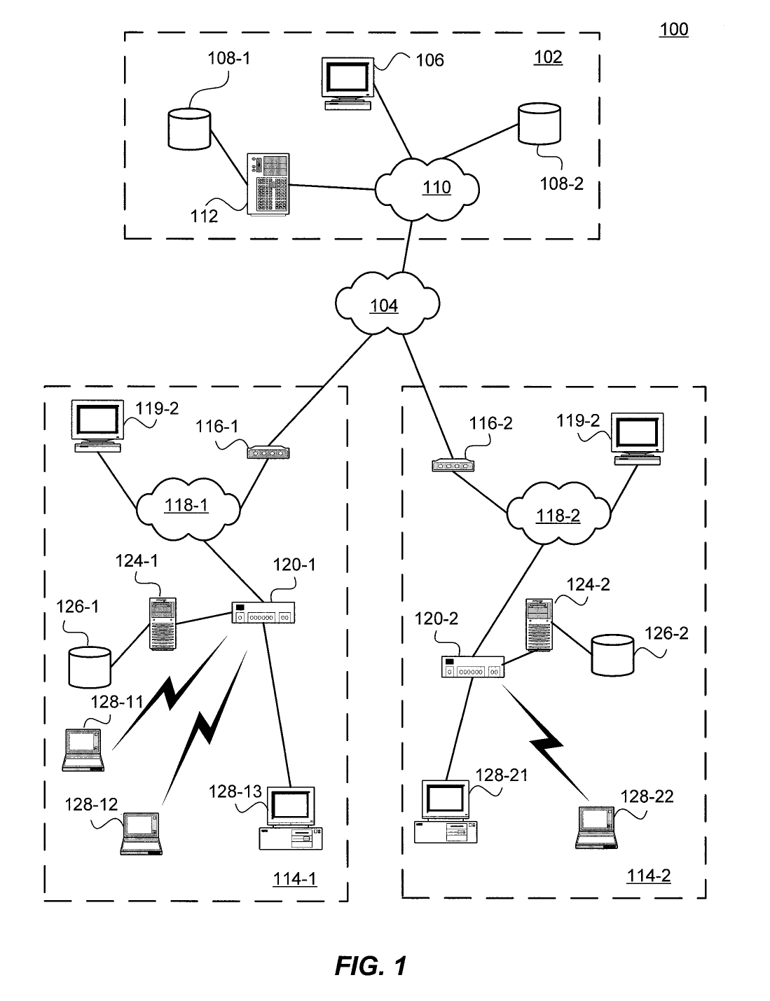

Having described embodiments of the invention generally, attention is directed to FIG. 1, which illustrates an exemplary system 100 according to embodiments of the invention. It should be apparent to those skilled in the art in light of the disclosure herein that the system 100 is merely exemplary of a number of possible system embodiments. The system 100 includes a host computer system 102 and a network 104. The host computer system 102 may include one or more computing device 106, one or more data storage arrangements 108, one or more internal networks 110, one or more servers 112, and/or the like. All the elements of the host computer system 102 may be collocated at a single physical location or may be distributed across a vast geographic area. In some embodiments, the host computer system 102 is a single computing device with its associated storage arrangement. Many other examples are possible.

The data storage arrangement 108-1 may be a database of users. The data storage arrangement 108-2 may be a database of advertisers. The host computer system 102 also may include server software that interacts with user computers to render tool bar content and/or applications within a browser content window operating on a user computer.

The network 104 may be any of a variety of networks known to those skilled in the art. For example, the network may be any wide area network, an intranet, any local area network, and/or the like. The network 104 may include wired and/or wireless links. In a specific embodiment, the network 104 is the Internet.

The system 100 also includes one or more network access locations 114. A network access location 114 (aka, venue), may be any physical location at which network access may be provided. The venue may be a hotel, an airport, a restaurant or bar, a city, an airplane, an office complex, a convention center, and/or the like. Generally, a venue includes an Internet access hub 116, a private network 118, and user computers 119 that have access to the private network. Additionally, each venue 114 includes an access hub 120, a local server 124, and a local database 126. Users using user computers 128 access the network 104 via the hub 120 via wired or wireless connections. The local server 126 hosts local functions, and, in some embodiments, replaces the host computer system 102. User and/or advertising information may be maintained on the local database 126.

In a specific embodiment, the venue 114-1 is a hotel and the network 104 is the Internet. A user interfaces a user computer 128-13 to the network 104 via a wired connection and the hub 120-1. The user receives a “splash” page through which the user may be required to register and/or obtain a userID and password. The user's registration information is stored at either the local database 126-1 or a database associated with the host computer system 102. The splash page is hosted by either the local server 124-1 or a server at the host computer system 102.

Following registration, the user is able to access the network 104. According to embodiments of the invention, web pages requested by the user are intercepted by the hub 120-1, and code is inserted to create the tool bar above the content in the content area of the web page. The user then may interact with the tool bar to operate any functions provided by the tool bar. The user may be unable to access any other network resources prior to completing the registration/logon process. In some embodiments, however, the user is able to access other functions provided by the network (e.g., email) without completing the registration and/or without having a tool bar rendered on the user's display.

During the registration process, demographic information about the user may be collected. This may include, for example, the user's age, gender, income, residence address, interests, and/or the like. The user demographic information is used along with venue-specific information to determine items to place in the user tool bar within the user's browser.

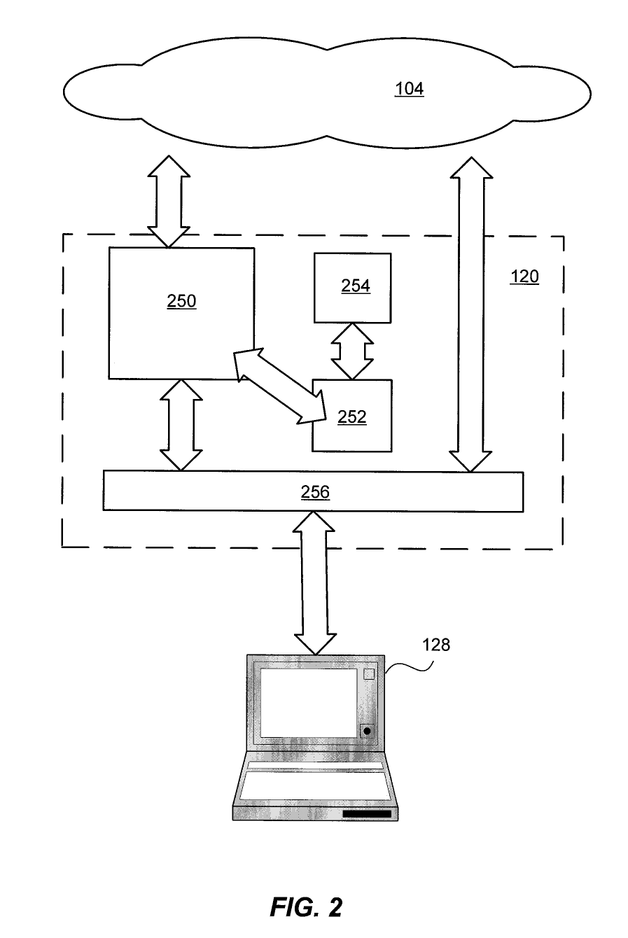

Attention is directed to FIG. 2, which illustrates an embodiment of the access hub 120 in greater detail. The hub 120 includes a transparent proxy 250, an injection modification engine 252, a content modification engine 254, and a routing/vectoring engine 256. According to some embodiments, the transport proxy 250 intercepts inbound responses to user requests for network resources. For example, when a user requests to visit a web site, the server hosting the web site returns a stream of code (e.g., HTML code) that causes a page of the web site to be rendered in the user's web browser. The transparent proxy 250 recognizes the stream of code and modifies it according to embodiments of the present invention. In specific embodiments, the transparent proxy 250 passes a portion of the code to the injection engine 252. The injection engine 252 works in combination with the content modification engine 254 to place tool bar rendering code into the stream of code from the web server. The modified stream of code is then passed to the user's web browser via the routing/vectoring engine 256, which renders the web page at the user computer. This rendering, however, includes a tool bar according to embodiments of the invention, which tool bar is not present in the web page when the web page is rendered on user computers not accessing the page through the hub 250.

In a specific embodiments, the injected code is Macromedia Flash code. The code may include embedded external calls that acquire tool bar content and/or applications from a local server 126 and/or a server at the host computer system 108.

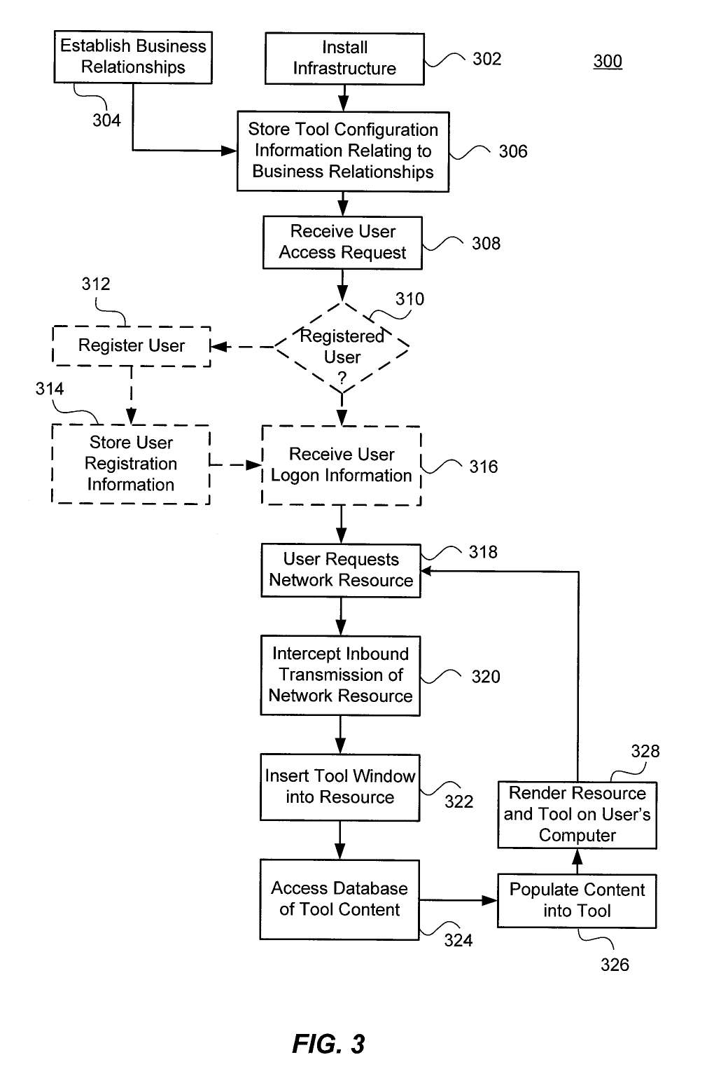

Having described a system according to embodiments of the invention, attention is directed to FIG. 3, which illustrates an exemplary method 300 according to embodiments of the invention. The method 300 may be implemented in the system 100 of FIG. 1 or other appropriate system. It should be appreciated that the method 300 is merely exemplary and other exemplary embodiments may include more, fewer, or different steps than those illustrates and described herein. Moreover, those skilled in the art will appreciate that the steps illustrated and described herein may be traversed in different orders than those shown here.

The method 300 begins at block 302 at which location any necessary infrastructure is installed at a venue. At block 304, business relationships are established. The business relationships may be with venue owners or operators, advertisers, equipment providers, and/or the like. At block 306, tool configuration information relating to the business relationships, infrastructure, and/or the like is stored, at which point, the venue is prepared to provide access to users.

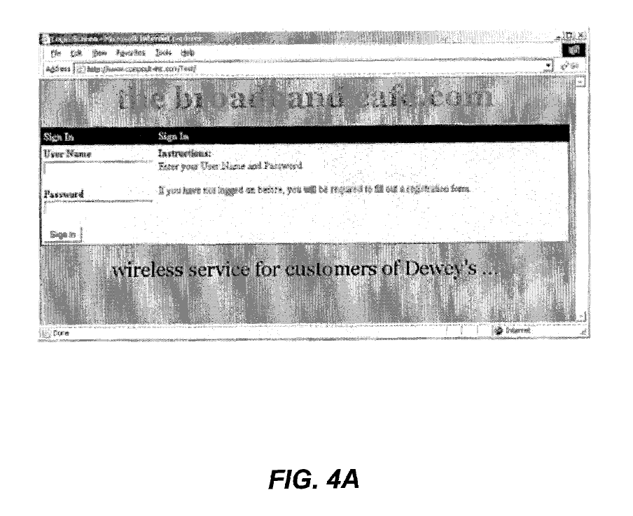

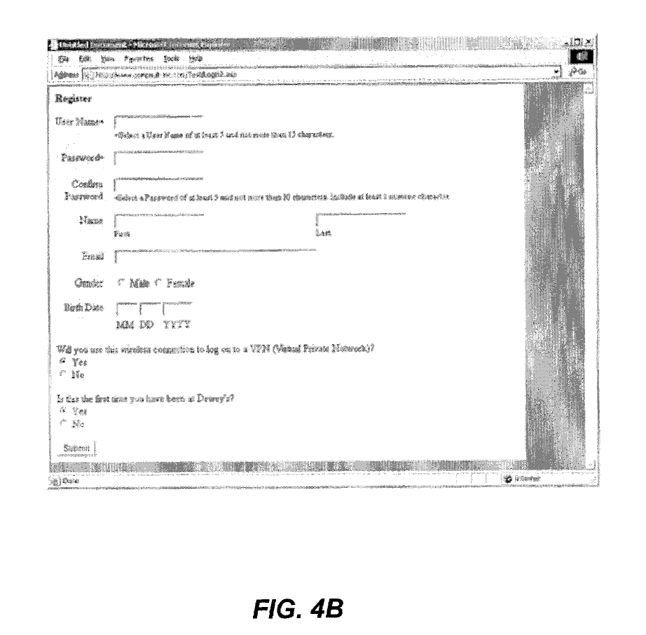

At block 308, a network access request is received from a user. This may be by way of a wired connection or a wireless connection. In a specific embodiment, the user initiates a browser session through which the user accesses the network. The user may be presented with a “splash” page that collects a userlD and password from the user. Otherwise, the user is unable to access the network. An exemplary screen shot for accomplishing this is provided at FIG. 4A.

At block 310, a determination is made whether the user is a registered user. This may be accomplished by having the user select a link that takes the user to a registration page, such as the one provided at FIG. 4B. At blocks 312 and 314, the information is collected and stored. At block 316, a user is logged onto the network and allowed to request network resources (e.g., web pages).

Those skilled in the art will appreciate that the logon and registration pages are merely exemplary, and other examples according to other embodiments may collect more, less, or different information. Moreover, blocks 310, 312, 314, 316 are shown in dotted lines to emphasize that registration is optional. In some embodiments, users are allowed to access the network without providing any registration information and without being a registered user. In other embodiments, the registration information is requested but providing it is optional. Whether the registration information is optional or even presented may be the decision of the venue owner/operator, rather that the network access provider. Many such possibilities exist.

Continuing with the description of the method 300, at block 318 a user requests a network resource. In a specific embodiments, the user requests a web page from the Internet. This may be accomplished by typing a URL in a web browser, selecting a link from the user's “home page,” having the user's browser request the user's default home page with no further input by the user, selecting a web page from the user's “favorites” menu, and/or any of a number of well known ways for requesting a web page.

At block 320, the inbound transmission of the requested network resource is intercepted. In a specific embodiments, this is accomplished by the access hub 120 of FIGS. 1 and 2. The access hub recognizes the inbound transmission as an HTML stream, or other web page rendering code, and holds the stream prior to sending it to the user/requestor.

At block 322, the access hub inserts tool bar code into the inbound transmission, which tool bar code is programmed to create a tool bar window within the content rendering window of the user's web browser. In a specific embodiment, the access hub inserts a small amount of Macromedia Flash code into the inbound transmission stream.

At block 324, the code comprised by the inbound stream and the tool bar code are executed by the user's web browser. In executing the tool bar code, external calls for content and/or applications are performed. The request may be addressed to a local server (e.g., the local server 124 from FIG. 1) or a remote server (e.g., host computer server 112 of FIG. 1). Hence, the content and/or applications returned in response to the request may be changed without changing the function of the access hub. The access hub merely places sufficient code to create a tool bar window and request content from an external source.

In some embodiments, the content source may include calls to still other content sources. For example, the local server 124 may include basic content, which content is provided to the user's web browser in response to the external call. Additionally, however, the local server 124 may refer the user's browser to yet more content at the server 112 at the host computer system 102. Many such examples exist.

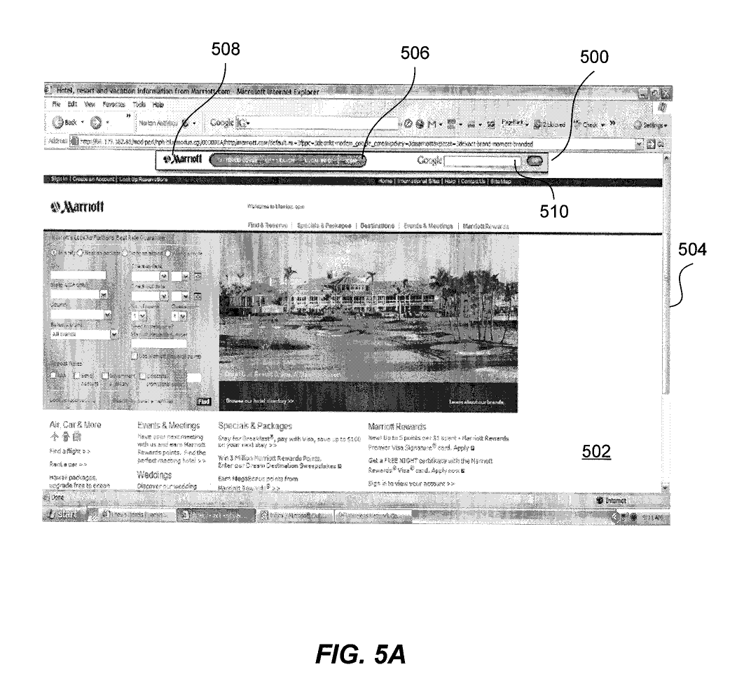

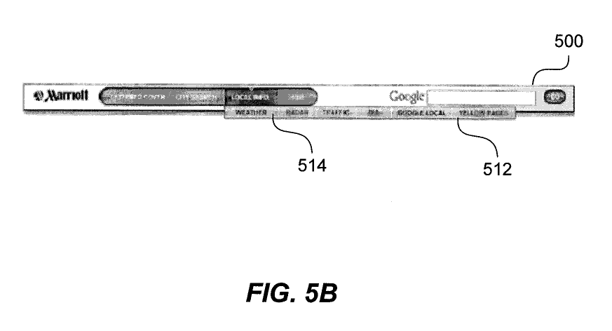

At block 326, the content from all sources is populated into the tool bar and the tool bar is rendered, along with the network resource, on the user's computer at block 328. FIGS. 5A and 5B depict the tool bar rendered in a user's web browser window and a detailed view of the tool bar with a dropdown menu displayed, respectively. The tool bar as depicted in FIGS. 5A and 5B is discussed in greater detail hereinafter.

Thereafter, the user may request additional network resources back at block 318. The request may take place in any of the ways previously described. Additionally, however, the user may request the network resource via the tool bar. The additional network resources are rendered in the content area of the user's web browser window along with the tool bar, as previously described. In other words, the tool bar persists, within the content area of the user's web browser window, throughout the user's browsing session for most network resources the user requests via the access hub.

In some embodiments, the user is also able to initiate applications provided to the user via the tool bar. For example, the user may send instant messages via the tool bar, participate in conference sessions, engage in voice over Internet Protocol (VoIP) sessions, and/or the like.

In some embodiments, a web page is modified twice, once before it has been rendered by the browser and a second time after it has been rendered by the browser using, for example, JavaScript. The modification prior to being rendered by the browser includes inserting a JavaScript that creates a location for the toolbar. The JavaScript may be specifically designed to insert the toolbar and may be different, depending on how the page is structured. Once the page has been fully downloaded and rendered by the browser, the JavaScript executes and makes the changes necessary to create the toolbar and its associated functionality.

In a specific example of the foregoing, when the content modification engine 254 detects a page being requested by a client browser, it analyzes the page to determine how to insert the toolbar into the page. The content modification engine 254 creates a custom JavaScript, specifically tailored to the page being requested, and saves it in memory with a unique identifier for later retrieval by the browser. The content modification engine 254 then creates and inserts a link to the script into the HTML stream as it passes back to the client browser. As the browser renders the page, it sees the script link with the unique identifier attached and requests to download the script. The content modification engine 254 detects and intercepts the request transparently to the client browser and sends back the correct, unique script for the page being modified. The script and its unique identifier are then removed from memory, thereby preventing further requests. This offers a limited amount of protection for the JavaScript so that a user cannot easily “steal” it. Even if a user were able to view the JavaScript used to make the modifications to the page, the script would be so customized to the page that it would be virtually useless to the user.

FIG. 5A depicts a tool bar 500, according to embodiments of the invention, rendered in a content area 502, of a web browser window 504. The tool bar includes buttons 506, or other selection mechanisms, for accessing content and/or additional network resources. The selection mechanisms may include pick lists, dropdown menus, and/or the like. The tool bar also may include a logo 508, which may identify a sponsor of the network access provided to the user. The tool bar also may include a search engine 510. Many possibilities exist. FIG. 5B depicts the tool bar 500 having a dropdown menu 512 selected. The dropdown menu 512 include selection mechanisms 514 for additional network resources.

Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention. Accordingly, the above description should not be taken as limiting the scope of the invention, which is defined in the following claims.

What is claimed is:

1. A method of providing access to a network, comprising:
at a network access point, receiving from a user computer a request for a network resource;
forwarding the request to the network;
at the network access point, intercepting an inbound transmission in response to the request, wherein the transmission includes the network resource and wherein the transmission is directed to the user computer;
inserting code into the resource;
forwarding the resource to the user computer; and
at the user computer, executing the code, wherein the code is programmed to render a tool bar in a content area of a web browser window rendered on a display associated with the user computer.

2. The method of claim 1, wherein the tool bar includes one or more selections from a group consisting of:
button;
dropdown menu;
pick list;
sponsor logo; and
search engine.

3. The method of claim 1, wherein executing the code comprises:
requesting tool bar content from a server local to the access point;
receiving the request at the server;
providing the content to the user computer; and
placing the content in the tool bar.

4. The method of claim 3, wherein the content comprises advertising.

5. The method of claim 3, wherein the content comprises one or more applications.

6. The method of claim 5, wherein the one or more applications are selected from a group consisting of:
instant messaging;
conferencing;
media streaming; and
voice messaging.

7. The method of claim 3, wherein the content includes code programmed to request additional content from a server remote from the access point.

8. The method of claim 1, wherein executing the code comprises:
requesting tool bar content from a server remote from the access point;
receiving the request at the server;
providing the content to the user computer; and
placing the content in the tool bar.

9. The method of claim 1, wherein the code comprises Macromedia Flash code.

10. A network access hub, comprising:
means for intercepting an inbound transmission of a network resource requested from a user computer; and
means for inserting code into the inbound transmission, wherein the code is programmed to render a tool bar in a content area of a web browser window operating on the requesting user computer.

11. The network access hub of claim 10, wherein the code comprises Macromedia Flash code.

12. The network access hub of claim 10, wherein the tool bar includes one or more selections from a group consisting of:
button;
dropdown menu;
pick list;
sponsor logo; and
search engine.

13. The network access hub of claim 10, wherein the code:
requests tool bar content from a server remote from the access point;
receive the request from the server; and
place the content in the tool bar.

14. A method of providing network access, comprising:
establishing business relationships with one or more advertisers;
storing tool bar content related to the advertiser at a server;
at an access point, intercepting an inbound transmission of a network resource requested from a user computer;
inserting code into the inbound transmission, wherein the code is programmed to render a tool bar in a content area of a web browser window operating on the requesting user computer; and
executing the code at the user computer, wherein executing the code includes requesting the tool bar content from the server.

15. The method of claim 14, wherein the code comprises Macromedia Flash code.

16. A system for providing network access, comprising:
a server configured to store content for a tool bar; and
a network access hub configured to:
intercept an inbound transmission of a network resource requested from a user computer; and
insert code into the inbound transmission, wherein the code is programmed to render the tool bar in a content area of a web browser window operating on the requesting user computer;
wherein the code is further configured to request the content from the server and populate the content into the tool bar.

17. The method of claim 16, wherein the content comprises advertising.

18. The method of claim 16, wherein the code is further configured to receive content pushed to the tool bar from the server and populate the content into the tool bar.

19. The method of claim 16, wherein the content comprises one or more applications.

20. The method of claim 19, wherein the one or more applications are selected from a group consisting of:
instant messaging;
conferencing;
media streaming;
alerts; and
voice messaging.

21. The method of claim 16, wherein the server is remote from the network access hub.
